(19) United States
(12) Patent Application Publication
(10) Pub. No.: US 2022/0024525 A1
(43) Pub. Date: Jan. 27, 2022

(54) VEHICLE WITH POWER SIDEWALL EXTENDER

(71) Applicant: Inteva Products, LLC, Troy, MI (US)

(72) Inventor: Brian H. Staser, Oxford, MI (US)

(21) Appl. No.: 17/376,988

(22) Filed: Jul. 15, 2021

Related U.S. Application Data
(60) Provisional application No. 63/054,633, filed on Jul. 21, 2020.

(51) Int. Cl. B62D 33/027

(52) U.S. Cl. CPC B62D 33/0273

(57) ABSTRACT

A power deployable extension system configured for use with a pickup truck bed, including: a plurality of structural extensions configured to be stored internally within sidewalls, a forward wall and a tailgate of the pickup truck bed, each of the plurality of structural extensions having a top rail portion secured to a plurality of vertical portions that are each slidably received within an opening located on a top portion of the sidewalls, the forward wall and the tailgate of the pickup truck bed.

### CROSS REFERENCE TO RELATED APPLICATIONS

This application claims the benefit of U.S. Provisional Patent Application Ser. No. 63/054,633 filed on Jul. 21, 2020, the contents of which are incorporated herein by reference thereto.

### BACKGROUND

Exemplary embodiments of the present disclosure pertain to the art of sidewall extenders for pickup trucks.

The current state of the art in pickup bed sidewall extenders are aftermarket manually installed features. These are typically wood slat assemblies that slip into slots in the top of the pick-up bed sidewalls. These wall extenders also do not extend a height of the tailgate, just the sidewalls.

Manual systems are stored outside of the vehicle and must be installed to the sidewalls by lifting them and inserting the extension into the manufacture's slots in the top of the sidewalls. Some versions have swinging doors hanging from the sidewalls and some have brackets that can be attached to the liftgate to add a slat wall there as well.

Accordingly, It is desirable to have a power deployable extension system that allows the bed of a pickup truck to properly carry taller items.

### BRIEF DESCRIPTION

Disclosed is a power deployable extension system configured for use with a pickup truck bed, including: a plurality of structural extensions configured to be stored internally within sidewalls, a forward wall and a tailgate of the pickup truck bed, each of the plurality of structural extensions having a top rail portion secured to a plurality of vertical portions that are each slidably received within an opening located on a top portion of the sidewalls, the forward wall and the tailgate of the pickup truck bed.

In addition to one or more of the features described above, or as an alternative to any of the foregoing embodiments, the plurality of vertical portions are a solid member.

In addition to one or more of the features described above, or as an alternative to any of the foregoing embodiments, the plurality of vertical portions are a telescoping portion.

In addition to one or more of the features described above, or as an alternative to any of the foregoing embodiments, each one of the plurality of structural extensions is operably coupled to at least one spindle drive in order to deploy the plurality of structural extensions from the sidewalls, the forward wall and the tailgate of the pickup truck bed.

In addition to one or more of the features described above, or as an alternative to any of the foregoing embodiments, each one of the plurality of structural extensions is capable of variable movement with respect to the sidewalls, the forward wall and the tailgate of the pickup truck bed by the at least one spindle drive.

In addition to one or more of the features described above, or as an alternative to any of the foregoing embodiments, each one of the plurality of structural extensions is operably coupled to two spindle drives in order to deploy the plurality of structural extensions from the sidewalls, the forward wall and the tailgate of the pickup truck bed.

In addition to one or more of the features described above, or as an alternative to any of the foregoing embodiments, the plurality of vertical portions are a solid member.

In addition to one or more of the features described above, or as an alternative to any of the foregoing embodiments, the plurality of vertical portions are a telescoping portion.

In addition to one or more of the features described above, or as an alternative to any of the foregoing embodiments, the plurality of vertical portions are a solid member.

In addition to one or more of the features described above, or as an alternative to any of the foregoing embodiments, the plurality of vertical portions are a solid member.

Also disclosed is a pickup truck bed, including: a power deployable extension system, including; a plurality of structural extensions configured to be stored internally within sidewalls, a forward wall and a tailgate of the pickup truck bed, each of the plurality of structural extensions having a top rail portion secured to a plurality of vertical portions that are each slidably received within an opening located on a top portion of the sidewalls, the forward wall and the tailgate of the pickup truck bed.

In addition to one or more of the features described above, or as an alternative to any of the foregoing embodiments, the plurality of vertical portions are a solid member.

In addition to one or more of the features described above, or as an alternative to any of the foregoing embodiments, the plurality of vertical portions are a telescoping portion.

In addition to one or more of the features described above, or as an alternative to any of the foregoing embodiments, each one of the plurality of structural extensions is operably coupled to at least one spindle drive in order to deploy the plurality of structural extensions from the sidewalls, the forward wall and the tailgate of the pickup truck bed.

In addition to one or more of the features described above, or as an alternative to any of the foregoing embodiments, each one of the plurality of structural extensions is capable of variable movement with respect to the sidewalls, the forward wall and the tailgate of the pickup truck bed by the at least one spindle drive.

In addition to one or more of the features described above, or as an alternative to any of the foregoing embodiments, each one of the plurality of structural extensions is operably coupled to two spindle drives in order to deploy the plurality of structural extensions from the sidewalls, the forward wall and the tailgate of the pickup truck bed.

In addition to one or more of the features described above, or as an alternative to any of the foregoing embodiments, the plurality of vertical portions are a solid member.

In addition to one or more of the features described above, or as an alternative to any of the foregoing embodiments, the plurality of vertical portions are a telescoping portion.

In addition to one or more of the features described above, or as an alternative to any of the foregoing embodiments, the plurality of vertical portions are a solid member.

Also disclosed is a method of providing a plurality of structural extensions of a pickup truck bed, the method including the steps of: slidably mounting each of the plurality of structural extensions within an opening located on a top portion of sidewalls, a forward wall and a tailgate of the pickup truck bed, each of the plurality of structural extensions having a top rail portion secured to a plurality of vertical portions; and coupling each of the plurality of structural extensions to at least one spindle drive.

### BRIEF DESCRIPTION OF THE DRAWINGS

The following descriptions should not be considered limiting in any way. With reference to the accompanying drawings, like elements are numbered alike:

FIGS. 1A and 1B are perspective views of a pickup truck bed with a power deployable extension system in accordance with an embodiment of the present disclosure; and

FIG. 2 is a spindle drive used to lift each section of the power deployable extension system in accordance with an embodiment of the present disclosure.

### DETAILED DESCRIPTION

A detailed description of one or more embodiments of the disclosed apparatus and method are presented herein by way of exemplification and not limitation with reference to the Figures.

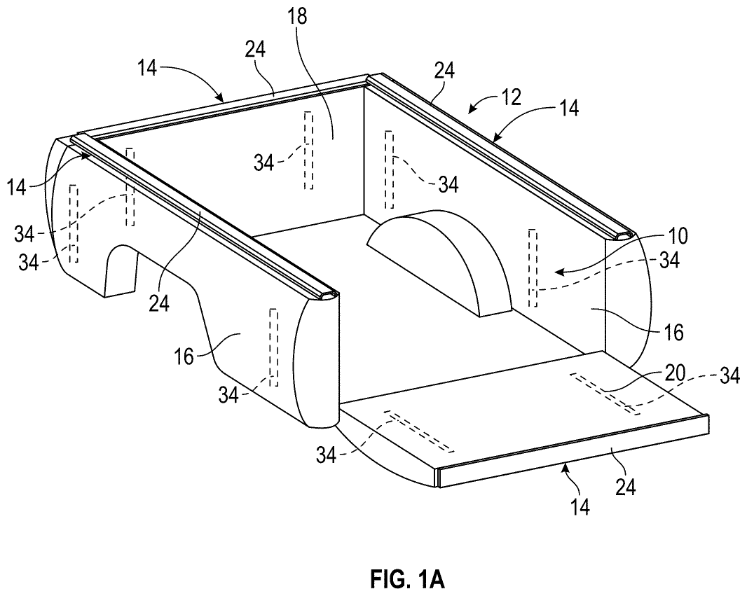

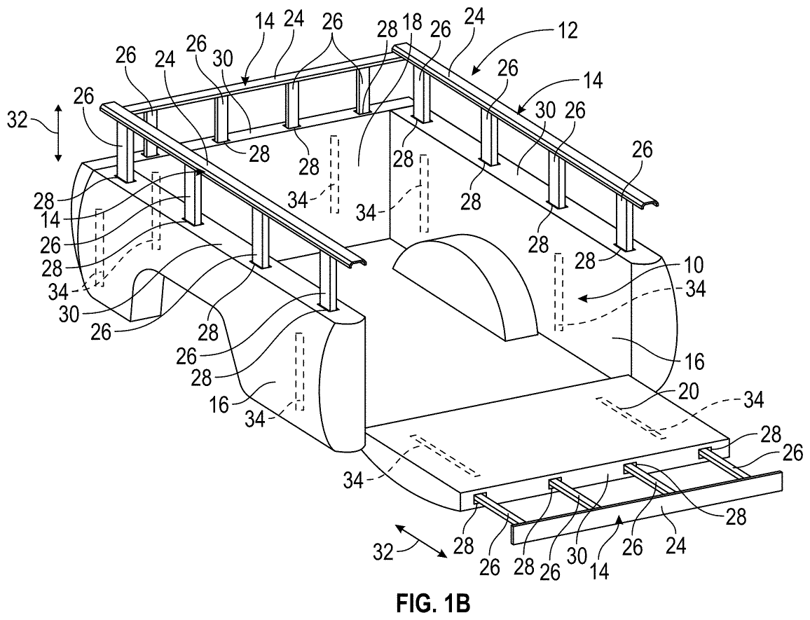

FIGS. 1A and 1B are perspective views of a pickup truck bed 10 with a power deployable extension system 12 in accordance with an embodiment of the present disclosure. In FIG. 1A the power deployable extension system 12 is in a stowed position and in FIG. 1B the power deployable extension system 12 is in a deployed position.

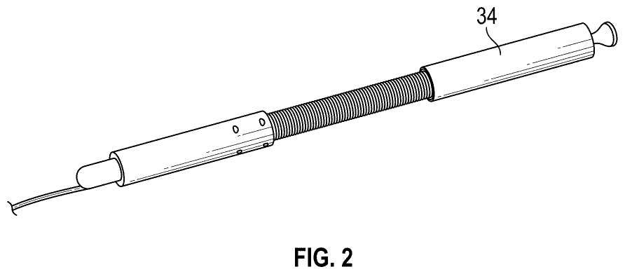

FIG. 2 is a spindle drive used to lift each section of the power deployable extension system in accordance with an embodiment of the present disclosure.

In one embodiment, the power deployable extension system 12 would be installed into the pickup truck bed 10 by the original equipment manufacturer (OEM) by for example, at a manufacturing plant.

As illustrated, the power deployable extension system 12 has a plurality of structural extensions 14 that are stored in the truck bed 10 sidewalls 16, forward wall 18 and tailgate 20 when the power deployable extension system 12 is in the stowed position. Each of the plurality of structural extensions 14 has a top rail portion 24 secured to a plurality of vertical portions 26 that are each slidably received within an opening 28 located on a top portion 30 of the sidewalls 16, forward wall 18 and tailgate 20. In one embodiment, the plurality of vertical portions 26 may be a solid member or alternatively they may be a telescoping portion.

Upon activation of the power deployable extension system 12, the top rail portion 24 of the sidewalls 16, forward wall 18 and tailgate 20 can be extended from a stowed position wherein the top rail portion 24 is resting on top of the top portion 30 to a deployed position to any height within the range of the power deployable extension system 12. As the top rail portion 24 moves to a deployed position the vertical portions 24 slide up and down in the directions of arrows 32.

The top portion 30 of the sidewall below the top rail portion 24 remains a closed system so as to not collect dirt and debris. For example, when the top rail portion 24 of the plurality of structural extensions 14 is in the stowed position, the openings 28 are closed since the top rail portion 24 is resting upon the top portion 30. When the top rail portion 24 is moved to the deployed position such that the top rail portion is elevated from the top portion 30, the vertical portions 26 slide up and down in the directions of arrows 32 by moving within opening 28. In order to prevent dirt and debris from entering within opening 28 when the top rail portion 24 is elevated from the top portion 30 a gasket (e.g., rubber or otherwise) can be located about opening 28 so as to allow for movement of the vertical portions 26 in the directions of arrows 32 while preventing dirt and debris from entering opening 28.

The power deployable extension system 12 is fully internal to the sidewalls 16, forward wall 18 and tailgate 20 and can function with “smooth motion” (obstacle detection & speed control). The plurality of structural extensions 14 are fully internal to the inner and outer walls of the bed and tailgate and the height of the plurality of structural extensions 14 are variable within the range of full extension. Also, the structural extension 14 of the tailgate 20 can be used with the tailgate 20 up or down. When the tailgate 20 is down as shown in FIGS. 1A and 1B this associated extension 14 can function as a bed extension if desired.

In one embodiment, each one of the plurality of structural extensions 14 would use two spindle drives 34 (See FIG. 2) per section to extend the vertical portions 26 attached to the underside of the top rail portions 24. The spindle drives 34 being operably coupled to the vertical portions 26. Of course, the number of spindle drives may vary to be greater or less than 2 per section.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A power deployable extension system configured for use with a pickup truck bed, comprising:
a plurality of structural extensions configured to be stored internally within sidewalls, a forward wall and a tailgate of the pickup truck bed, each of the plurality of structural extensions having a top rail portion secured to a plurality of vertical portions that are each slidably received within an opening located on a top portion of the sidewalls, the forward wall and the tailgate of the pickup truck bed.

2. The power deployable extension system as in claim 1, wherein the plurality of vertical portions are a solid member.

3. The power deployable extension system as in claim 1, wherein the plurality of vertical portions are a telescoping portion.

4. The power deployable extension system as in claim 1, wherein each one of the plurality of structural extensions is operably coupled to at least one spindle drive in order to deploy the plurality of structural extensions from the sidewalls, the forward wall and the tailgate of the pickup truck bed.

5. The power deployable extension system as in claim 4, wherein each one of the plurality of structural extensions is capable of variable movement with respect to the sidewalls, the forward wall and the tailgate of the pickup truck bed by the at least one spindle drive.

6. The power deployable extension system as in claim 1, wherein each one of the plurality of structural extensions is operably coupled to two spindle drives in order to deploy the plurality of structural extensions from the sidewalls, the forward wall and the tailgate of the pickup truck bed.

7. The power deployable extension system as in claim 4, wherein the plurality of vertical portions are a solid member.

8. The power deployable extension system as in claim 4, wherein the plurality of vertical portions are a telescoping portion.

9. The power deployable extension system as in claim 5, wherein the plurality of vertical portions are a solid member.

10. The power deployable extension system as in claim 5, wherein the plurality of vertical portions are a solid member.

11. A pickup truck bed, comprising:
a power deployable extension system, comprising;
a plurality of structural extensions configured to be stored internally within sidewalls, a forward wall and a tailgate of the pickup truck bed, each of the plurality of structural extensions having a top rail portion secured to a plurality of vertical portions that are each slidably received within an opening located on a top portion of the sidewalls, the forward wall and the tailgate of the pickup truck bed.

12. The pickup truck bed as in claim 11, wherein the plurality of vertical portions are a solid member.

13. The pickup truck bed as in claim 11, wherein the plurality of vertical portions are a telescoping portion.

14. The pickup truck bed as in claim 11, wherein each one of the plurality of structural extensions is operably coupled to at least one spindle drive in order to deploy the plurality of structural extensions from the sidewalls, the forward wall and the tailgate of the pickup truck bed.

15. The pickup truck bed as in claim 14, wherein each one of the plurality of structural extensions is capable of variable movement with respect to the sidewalls, the forward wall and the tailgate of the pickup truck bed by the at least one spindle drive.

16. The pickup truck bed as in claim 11, wherein each one of the plurality of structural extensions is operably coupled to two spindle drives in order to deploy the plurality of structural extensions from the sidewalls, the forward wall and the tailgate of the pickup truck bed.

17. The pickup truck bed as in claim 14, wherein the plurality of vertical portions are a solid member.

18. The pickup truck bed as in claim 14, wherein the plurality of vertical portions are a telescoping portion.

19. The pickup truck bed as in claim 15, wherein the plurality of vertical portions are a solid member.

20. A method of providing a plurality of structural extensions of a pickup truck bed, comprising:
slidably mounting each of the plurality of structural extensions within an opening located on a top portion of sidewalls, a forward wall and a tailgate of the pickup truck bed, each of the plurality of structural extensions having a top rail portion secured to a plurality of vertical portions; and
coupling each of the plurality of structural extensions to at least one spindle drive.
